(19) United States
(12) Patent Application Publication
(10) Pub. No.: US 2008/0252786 A1
(43) Pub. Date: Oct. 16, 2008

(54) Systems and methods for creating displays

(76) Inventors: Charles Keith Tilford, St. Louis, MO (US); Eric Brett Tilford, Webster Groves, MO (US); Marc Kempter, Eureka, MO (US); James Cleveland JC Dillon, Kirkwood, MO (US); John Joseph Dames, St. Louis, MO (US); David Patrick Farmer, Sullivan, MO (US); Jason Andrew Stamp, St. Louis, MO (US)

Correspondence Address: LEWIS, RICE & FINGERSH, LC;ATTN: BOX IP DEPT., 500 NORTH BROADWAY, SUITE 2000, ST LOUIS, MO, 63102, US

(21) Appl. No.: 12/079,574

(22) Filed: Mar. 27, 2008

Related U.S. Application Data
(60) Provisional application No. 60/908,648, filed on Mar. 28, 2007.
(60) Provisional application No. 60/913,749, filed on Apr. 24, 2007.

(51) Int. Cl. H04N 5/14; G06F 17/00

(52) U.S. Cl. 348/571; 345/418; 348/E05.062

(57) ABSTRACT

Systems and a methods for providing interactive interpretation of a data stream having a temporal element. Specifically, the ability to interpret an input stream to provide a different video output whereby the input is modified by a second temporal stream so as to provide for an interpreted output which is time dependent.

### CROSS REFERENCE TO RELATED APPLICATION(S)

This Application claims the benefit of U.S. Provisional Patent Application Ser. No. 60/908,648 filed Mar. 28, 2007 and claims the benefit of U.S. Provisional Patent Application Ser. No. 60/913,749 filed Apr. 24, 2007. The entire disclosure of both these documents is herein incorporated by reference.

### BACKGROUND

1. Field of the Invention

This invention relates to systems and methods for providing and generating interactive visual, audio, or audiovisual presentations. These systems and methods may utilize multiple data streams having a temporal component obtained from a variety of media sources acting on each other to provide for a unique output.

2. Description of the Related Art

Recent upgrades in television and video screen technology have allowed for televisions to increase in screen size, while at the same time becoming thinner and easier to place in a room. Because of this, the large flat screen television is rapidly becoming ubiquitous in society. They are in people's houses, in bars and restaurants, and in businesses for use in videoconferencing or simply to provide distraction in waiting rooms. Further, digital screens and projectors are starting to find new use including as digital billboards and as store and window advertising tools.

While the screen is changing, the content being shown on the screen generally is not. When a large video screen is off it provides a large black void in a room and large screen televisions, when not in use, can often attract unwanted attention and be distracting to the décor of a room. In particular, the screen tends to draw the eye of the user because there is nothing to see. The question has been, because of this, how to keep the presence of a television from detracting from its surroundings.

To try and resolve the problem there have been a number of ad hoc solutions. In many instances, the television was hidden out of sight when its presence would be distracting. The television was often placed in a piece of furniture which could be used to cover the screen behind doors or panels, or was designed to disappear into the wall.

While this works, with flat panel TV's it often means that a large amount of additional space must be taken up in a room to hide the device. Still further, as the screens of televisions get larger, the doors or panels hiding the device also must get larger, which can make it harder to construct furniture which is still attractive and meets other design principles, while still being of sufficient size to hide the television.

In many places, the television is simply left on at all times so as to eliminate the black void. The problem with having televisions constantly going is that the content available to them can also serve to attract unwanted attention or can become boring and repetitive if viewed for any length of time. Television programming, as it has been available, is designed to attract the user's attention and specifically result in them being engaged by the provided programming. While this can be fine in a sports bar where patrons regularly come alone and are intending to watch televised sporting events, it can be undesirable in a person's home where they don't want the television show to become the central feature.

Further, as an advertising tool, the television can present as means to provide information, but it is passive, simply providing a constantly repeating loop of information which does not react to the user. Effectively it is playing “at” the user and cannot provide for a more fulfilling sales experience as can be provided by a living salesperson. The user cannot interact with the display, they can merely be a passive vessel for the information it provides. Therefore, the presentation of sales information is particularly problematic as there is a desire to present information quickly, but short repeated clips can often become unpopular as repetitive and annoying.

There have been studies done of children which have shown that the process of viewing an individual via a display such as a television, does not appear to impart as much learning to a child as the same information presented from a live person, even if both people are simply speaking and acting out the same actions. There has been some indication that the reason for this is that television watching is passive and disconnected. Somehow, the viewer knows that the person shown on the screen is not present and cannot hear or react to the viewer. The user of the display is disconnected from the content of the display, acting merely as an observer.

Video games have tried to allow the user to interact with the display. However, they are stilted as the user is still merely reacting. The video game generally does not react in an organic way with the user, rather it uses predefined or triggered responses to the input of a stimulus from the user. In effect a video game allows the user to change what they are observing in the game, and in some sense to influence the environment of the game. At the same time, the video game does not really react to the user. Instead the “reaction” of the computer is based on rules of motion and activity. For this reason many video game players do not enjoy playing against a “computer opponent” as the opponent is relatively predictable due to its use of predefined rules.

Other users have attempted to make the display interactive, by having the user react in the form of video artwork. However, in video art the display which holds the art is still designed to be passive. Interactivity is supplied by interaction of the user with the artist or surroundings of the display set, as opposed to the video image presented on the display. Even “live” video is not interactive, it is simply static video being created at the time the events are shown.

### SUMMARY

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of the above and other reasons in the art, there is a desire to provide for video, audio, or audiovisual presentation which may be generated live such as in an interactive display. That is, it is video which allows for the user to create and/or interact in real-time with the display instead of simply sitting and passively watching it, reacting to it, or acting outside of it. The construct of how the interaction takes place as well as what data is stimulating the generation of content can also be defined by the user.

There is described herein, among other things, a system by which audio and video content is procedurally generated from multiple sources and multiple stimulus (or data streams) with the influence of human interaction, or with internal or process interaction.

There is described herein, among other things, a system for generating a visual presentation, the system comprising: a display, for displaying a visual presentation; a memory, the memory including at least one piece of media which can be interpreted as a temporal data stream comprising a series of frames, wherein the frames can be presented serially as a visual presentation on the display; a controller, the controller including: an interpreter, the interpreter being capable of modifying a first temporal data stream associated with a first piece of media so as to utilize a first piece of media to generate a different visual presentation on the display.

In an embodiment of the system the controller further includes: An intermixer, the intermixer being capable of utilizing a second temporal data stream associated with a second piece of media to generate a series of variables. The series of variables may be temporally aligned with the series of frames and the interpreter interprets each of the frames in conjunction with the variables temporally aligned therewith.

In an embodiment of the system the first piece of media comprises a prerecorded video track the second piece of media comprises a prerecorded audio track and the audio track corresponds to the video track as each are from the same integrated content.

In an embodiment of the system, at least one of the first piece of media and the second piece of media may be procedurally generated in real-time and may comprise a user generated stimulus.

There is also described herein, a method of generating output on a display, the method comprising: providing a controller which includes an intermixer and an interpreter; providing to the controller at least two data streams; having the intermixer obtain from at least one of the at least two data streams at least one stimulus, the intermixer providing the stimulus to the interpreter; having the interpreter utilize the stimulus to modify at least one of the at least two data streams to produce an interpreted data stream; presenting the interpreted data stream on a display in real-time as it is produced.

In an embodiment of the method the controller comprises a computer and the intermixer and the interpreter comprise computer software.

In an embodiment of the method, at least one data stream obtained by the intermixer comprises prerecorded video, live generated video, prerecorded audio, or live generated audio.

In another embodiment of the method, at least one data stream obtained by the interpreter comprises prerecorded video, live generated video, prerecorded audio, or live generated audio.

There is also described herein, a computer readable memory for instructing a computer to generate displayed content, the computer readable memory comprising: computer readable instructions for obtaining at least one data stream and generating at least one stimulus from the at least one data stream; computer readable instructions for using the stimulus to modify at least one data stream to produce an interpreted data stream; computer readable instructions for presenting the interpreted data stream on a display in real-time as it is produced.

In an embodiment of the memory, only one data stream is used by all of the computer readable instructions. In an alternative embodiment, at least two different data streams are used by the computer readable instructions.

### BRIEF DESCRIPTION OF THE DRAWINGS

This patent or application file contains at least one drawing executed in color. Copies of this patent or patent application publication with color drawing(s) will be provided by the Office upon request and payment of the necessary fee.

FIG. 1 shows a general block diagram of a layout of a video setup which can present interactive content.

FIG. 2 shows an overview of a flow chart indicating selection criteria for choosing how to generate content from two or more sources.

FIG. 3 shows a general diagram of an interface which could be used to select content.

FIG. 4 provides an example of a still image in original form, and as interpreted in color.

FIG. 5 provides a series of frames showing an interpretation of a live person in color.

FIG. 6 provides for a series of frames showing another interpretation of a live person interacting with video and being interpreted, in color.

FIG. 7 provides a series of frames showing an interpretation of frames from the video track of a movie.

FIG. 8 provides a flowchart showing an embodiment of stimulus collection and processing.

FIG. 9 shows an overview of an interpretation utilizing two stimulus inputs and interaction with preset sources.

### DESCRIPTION OF THE PREFERRED EMBODIMENT(S)

The following detailed description illustrates by way of example and not by way of limitation. Described herein, among other things, are systems for providing of interactive and live generated video and audiovisual presentations.

The systems and methods discussed herein may be used on any form of video presentation device which is generally referred to as a display (103). The display (103) may utilize any technology to generate a visual image, however, the display (103) will have a temporal component which allows the image on the display (103) to change over time. This is commonly called a video as opposed to a static display. The display (103) will generally be a larger screen video playback device such as, but not limited to, a television or digital projector. However, it is recognized that the technology is not dependent on the nature of playback, and therefore future visual image display technologies would also be useable with the systems and methods discussed herein.

Further, the systems and methods discussed herein are designed to provide for increasingly live generated, interactive content. This is crudely referred to as “organic” content as the reaction of the machine appears to move as the reaction of a human or other organic being rather than a machine. In some sense, the machine acquires what appears to be an increase in randomness of its actions, with the actions appearing completely unpredictable. However, it is recognized that such content, once generated, can also be recorded for later playback. In the same way that a live impromptu musical performance may be recorded and later played back, so may the live generated presentation of the present case be done the same way. It does not change the nature of the original generation.

Described herein, generally are systems and method for providing the generation of organically appearing interactive video displays. That is, the presentation of video material whereby the user (105) may react to the image on the display (103) and the image on the display (103) at least appears to the user (105) to react and change in response to input from the user (105). “Interaction” or “interactive” are terms with a variety of meanings and one can look at a traditional video game and say it is interactive in that, by altering the video game controller, the user (105) can alter the appearance of the display on the screen. This interaction is not, however, “interactive” in the same sense as the display discussed herein. In a video game, the appearance of the display is created through the use of environmental rules which effectively define the universe the user (105) is in. This universe can be “viewed” by the user in accordance with those rules but the rules do not change. Further, the user is interacting via an avatar which appears in the game, not directly with the screen.

This is effectively a one way interaction. There is a stream of data provided to the user (105). While the user (105) can select what part of that data is to be displayed, they cannot truly alter the stream of data comprising the display. For example, using a dungeon crawl video game, the video game cannot alter the type or number of monsters which appear around a corner based on the weapons a user's (105) avatar is currently carrying, how much health the avatar has, or even how cautiously the user (105) approaches the corner. In effect, the game utilizes only a single stimulus in its decision making. Has the user triggered activation of the pre-located monster to act in accordance with its predefined rules of motion or not. The game also cannot determine that the actual user (105) is currently sitting, standing or even laying in bed. Instead, the monsters are preset and their movement, which is based on fixed rules, is simply triggered as the user's (105) avatar approaches close enough to trigger their actions. This is the operation of video games today. The “computer player” does not react to the user's (105) actions directly. Instead, the user (105) reacts to the computer which simply plays in accordance with its defined rules and whether a particular stimulus has been received. To put it another way, the computer “player” cannot adapt to the play style of the human player to improve the computer's play by reacting to the actual user. Even interactive game systems which try to get the user to move do not react to the user's movement. They simply detect that a particular type of movement occurs, and update data accordingly.

For this reason, many popular video games today allow human players to play against other human players. In this type of game, each player must react to the actions of the opposing player, which are not in accordance with defined rules and may change and alter throughout the course of the game. This can provide more rewarding game play as the other player is a more dynamic opponent.

Comparatively, one could consider watching a movie stored on a DVD, which is also a reactive experience. While many DVDs allow the user (105) to change between different views or even camera angles, the user (105) cannot alter the underlying stream of presentation with another stream of data. They are simply selecting which data stream is presented at any time and are simply watching the provided content. They cannot tell the heroine of a horror movie not to open a door regardless of how many times they say it. The movie's plot and content is fixed. While the user (105) can choose to not view all of it, they cannot alter the outcome.

In the present discussion, the interaction is not that the user (105) may only react to a computer presentation, the computer may appear to interact with their actions allowing for a more interesting viewing experience as the user (105) can alter the display. The display (103) therefore reacts to them in a more open and direct fashion. This disclosure will focus on the use of any form of data which is used to provide for a data stream, which is a string of data having a temporal component, such as images, audio, or audiovisual presentations, that are dependent on time and the use of multiple such data streams (stimuli) in controlling the display (103).

The interaction with a user (105) and the display (103) will generally occur in three forms, which are interrelated in their creation. In the first instance, the user (105) will act essentially as a “mixer.” In this case the user (105) utilizes existing data as the raw material, but is determining at any instant how that data is to be used on the display (103). The controller (101) of the system (100) appears to be interacting to the user (105) by utilizing the data as indicated so as to provide the requested display (103). In this version, any data stream, or component of a data stream, may be used to serve as an input (stimulus), the user (105) interacting by how the data streams (stimulus) are selected and how they interact.

In the next stage the interactivity is intensified as the user (105) no longer simply selects between prerecorded input systems, but directly provides at least one data stream which is in turn interpreted and intermixed. In this way, the user (105) becomes not only the selector of input, but also, at least partially, the input.

Finally, the user (105) is taken out of the equation as a selector of interaction, and becomes the source of all or most of the data streams, meaning that the user's (105) actions directly influence the appearance on the display (103). The user (105) can then react to the display (103) presented so as to produce an interactive response.

An important component of the systems and methods discussed herein is that the data streams utilized include a temporal component. The nature of a temporal component of data can be illustrated with reference to audio or video. A song, while it is being played, changes over time in the sound waves that are heard and interpreted by the user's (105) ear, thus providing that sound is a temporal data stream.

Even a constant tone has a temporal component, the user's (105) ear hearing a constant tone is not hearing merely a single crest of a single sound wave. They are hearing a series of such crests and troughs over time. Compare that to the text on this page. The page itself has no temporal component as the text is unchanging. However, the user (105) of the page may give it a temporal component by reading it over time. In this way each word becomes associated with a particular time that it was read and the data of the page gains a temporal component. In this way effectively any input may be used as a source of information (stimulus). So for example, while a video stream has a clear temporal component, a stimulus which may be generated from the video based on a delta of color change over time. Alternatively, the video could be used to calculate a per pixel velocity. Even a static image could provide a temporal stimulus by simply creating a form a data stream from static data. Like reading the page, a static image could be viewed pixel by pixel to provide basically the same stimulus (e.g. color change) over time. In this case the temporal component is actually created by allowing a change in space to be read temporally, creating a temporal stream.

The data streams discussed herein therefore will represent data which has a temporal component, generally in the way it is to be presented to a user (105). That is, the data will provide for an image, sound, or other detectable quality which is effected by the time when a portion or “frame” of the data stream is presented. Effectively, for any subdivision of time, there is some data associated with that time so that each piece of data has two elements, the data element itself and the time at which it is presented. The specific item of data is therefore transitory. The stream representing the transitory pieces of data as presented and detected. It should be recognized that the item of data need not change for the item to still be transitory. A constant tone of sound includes transitory data, specifically which wave or waves impacts the user's (105) ear or is transmitted by a speaker or similar device at any one instant in time. Once presented the data is removed and replaced with new data, even if that data is simply a repeat of prior data.

Traditional video is a very apt method for thinking of a temporal data stream as such video displays do not, by their very design, display an image which is ever static. Instead, the screen is constantly refreshing, replacing the existing image with a new one. In this way, a constant or unchanging image on a video display is not constant or unchanging, but is actually a temporal stream of the same image repeatedly displayed a number of times in a row. This “refresh” of the screen allows the screen to display static images, as well as images that appear to the human eye to move due to shifting of portions of the image.

Discussed herein are systems and methods which allow for the user to alter the output of a core data stream by altering parameters of the core stream with a second, or adjusting stream, which also has a temporal component and is translated to a series of variables. Those variables are then used to adjust an interpretation of the core stream, over time, so as to present a new data stream. The variable input is referred to as a “stimulus.” That in it provides the stimulus which creates the alteration of the resulting data stream. In the same way that an analog audio signal “stimulates” the movement of a speaker panel, so to will the data stream “stimulus” stimulate an interaction in the resultant display stream. The interaction is not merely an overlay of the data stream, as would be the case of syncing sound to video for example, but actually produces a new data stream which is altered from the original due to it being modified by the introduction of the temporally changing variable and stimulus.

While this disclosure will focus on video, as that is the easiest to understand, it should be apparent that the systems and methods rely merely upon a data stream, and therefore the systems and methods can be used to alter any type of data stream including video, audio, audiovisual, or other data streams. Further, the systems and methods herein provide for atmospheric or “simple” reactions. The systems and methods are not designed to provide for a display image which can intelligently answer questions, but to provide for one which provides for a dramatic (and often artistic) reinterpretation of provided data so as to allow the user (105) to create new and changing images. It provides effectively for organically generated display based on specific stimulus from a specific point in time.

In order to understand the systems and methods it makes sense to show a basic layout of an embodiment of a system for providing an interactive display (100) which provides for various sources of input and manipulation of that input.

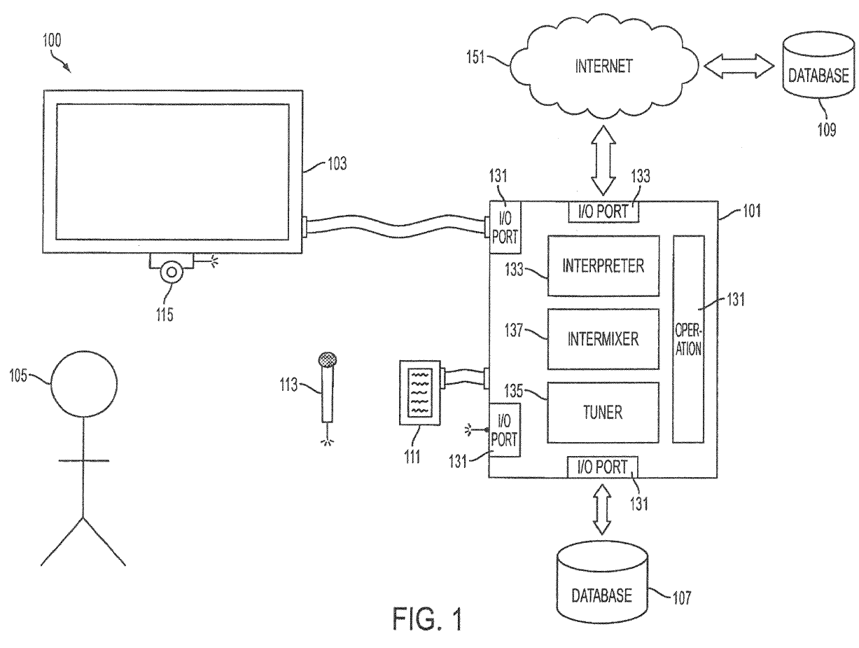

FIG. 1 provides for a general block diagram of a system (100) for providing for interactive video. In the system (100) there is provided a controller (101) which serves as the principal operational component of the system (100). The controller (101) will generally be some form of computer or other data processor including hardware and software for interpreting data streams. The controller (101) includes a number of functional components which will utilize and act on the data streams. The first functional component is simply the operational systems (131) which allow for a data stream to be obtained and utilized as well as common machine input and output interactions. Part of this is a driver for allowing the controller (101) to present data on the display (103) as a visual image over time and other standard and known computer components to allow for computation and related functions.

There is also included a component called an interpreter (133). The interpreter (133) component serves to take a data stream and interpret it. Specifically it allows for the data stream to be modified as it is presented so as to provide for a different display which, while based on an initial data stream, is not the initial data stream simply being displayed. The interpreter (133) effectively provides for the artistic component of the controller (101). By re-interpreting video or other media of an immediately recognizable form to a modified form, the modification necessarily provides for some unexpected change and for novelty in the display.

The second functional component is the tuner (135). The tuner (135) serves to provide for segregation and simultaneous playback of multiple channels of data, even if provided from a single source. As such, it allows for each piece of integrated content to be treated as a fully separable and accessible piece of media. For example, a movie video track and sound track which together are an integrated piece of content which can be treated as separate pieces of media.

The third functional component is an intermixer (137). The intermixer (137) acts with the interpreter (133) so as to provide for the ability of the interpreter (133) to alter the nature of its interpretation over time based on the input of variables. Specifically, as the interpreter (133) will serve to reinterpret a specific piece of data based on a process for modifying the data. The intermixer (137) will serve to feed the interpreter (133) the necessary variables for making the interpretation at any instant. To look at this another way, the intermixer serves to connect data streams to the resultant output.

Hooked to the controller is a display (103). This system provides for a visual presentation via the display (103) to a user (105) who is able to view a representation of a data stream which is displayed on the display (103). Attached to the controller (101) is also a local memory (107) which will include various stored data on storage media. Generally the data will be in digital form and will include digital representation of visual, audio, or audiovisual material which is referred to as “media.” For example the local stored media may include MP3 recordings, DVD technology, or similar recorded matter or other representations of such media. The local storage (107) may also include other stored data, again generally in digital format, such as standard computer data or programs.

The controller (101) is also connected to a network (151) via an Ethernet connection (153) or similar hookup which allows access to network (151) or other remote storage (109). Remote storage (109) is generally similar to local storage (107) however is located remotely from the controller (101) and may be under the control of a different individual which provides access to media on the remote storage (109). This access may be in the form of standard computer network or Internet communication protocols and associated communication standards. The connection (153) can comprise an Internet or similar connection, or connection to other computing devices or other controllers (101). The connection may be wired or wireless and may utilize any connection methodology known now or later discovered. It is not necessary that the controller (101) have access to both local storage (107) and network storage (109). However, it will generally be the case that the controller (101) is connected to at least one of them. The remote storage (109) also includes media which may be presented as a digital data stream.

Also connected to the controller (101) are sources of live input or live media. This includes in the depicted embodiment a control interface (111) which can accept input from a user by their touching or otherwise indicating a selection on the interface (111). There is no specific type of interface (111) required and an interface (111) can be any kind of device which is designed to translate action by the user (105) to purposefully indicate a particular piece of information to the controller (101), into instructions understood by the controller (101). Devices which could comprise the interface (111) include items such as keyboards (both language and musical), video game controllers, or other inputs such as pointing devices (e.g. a computer mouse), or a stylus or other motion detecting system, or touch screens.

In addition to the interface (111) There is also provided an audible input, such as a microphone (113) and a video input (115) such as a web camera. There may also be included another open input devices such as an artificial nose (smell sensor), light sensor, or similar devices. These devices are not designed to take in specific actions of a user (105) and translate them into preordained instructions as is the case with an interface (111). These devices are instead generally multi-variable inputs which may be used to provide for media more directly to the controller (101). For example, a video input (115) does not merely detect a single instruction, but a temporal data stream in the form of video. As should be apparent, connection from the controller (101) to any attached device may be any method including, without limitation, wired and wireless connections.

One should also recognize that there may be other sources of input available based on storage or detection. For example, the controller (101) could have in memory (107) or (109) computer code for generating computer animation systems. For example, there can be motion, lighting, and related effects which can be used to generate real-time animations, for example of flowing fluids, moving objects, or other items. Still further, the controller (101) will likely have access to other data streams which are simply in the environment in which controller operates. For instance, the controller may be able to access any of the myriad of wireless signals (e.g. TV broadcasts, radio broadcasts, Internet traffic, wireless telephone, wireless networks, or Bluetooth™ signals current in the air or on cables. Still further, the controller (101) may be able to monitor recursive streams of data, for example the current heat characteristics being emitted by its own processor or a mapping of which “cells” of RAM memory are currently in use.

In order to provide for interactive content on the display (103), the controller (101) will generally utilize software or hardware which provides for “interpretation” of input. As discussed above this functional block is called an interpreter (133) and serves to take the media in the form of a core data stream from being immediately recognizable to being less immediately recognizable which results in the production of an interpreted data stream.

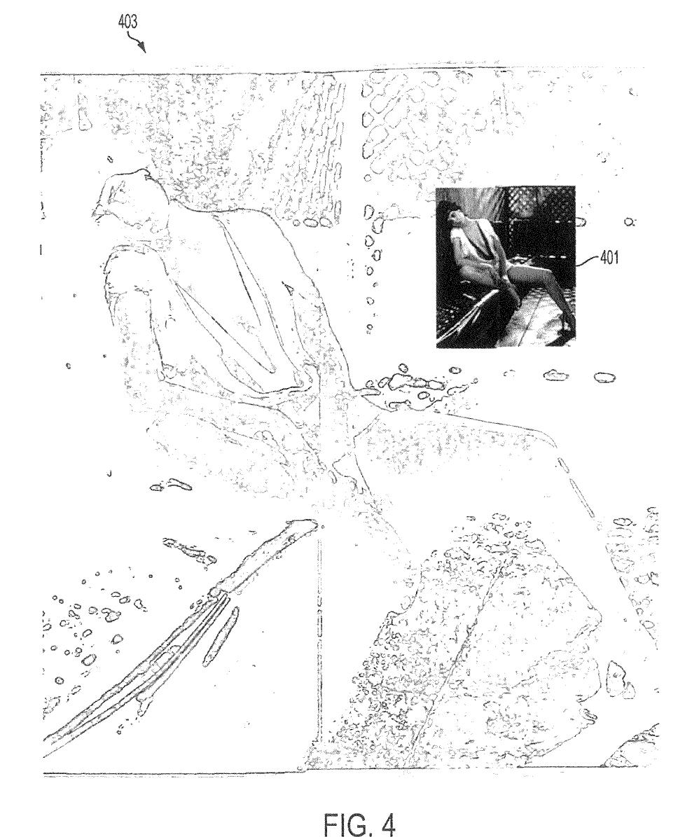

FIG. 4 provides for an example of a single image (401) (in this case a single photographic image) and how that image can be interpreted by interpreter (133). In this case, the interpreter (133) will take the image (401) and provide that the edges as detected electronically as differentiation between light and dark. Further, colors are to be reinterpreted (in this case black is white while other colors are represented by various colored hollow blobs) to provide for a new image (403). The original image (401) is inset on the new image (403) in this FIG. Examining the two images (401) and (403), it is clear that the latter image (403) is based on the former (401). However, if the latter interpreted image (403) is examined alone, the entire initial image (401) will not necessarily be obtainable. This static image provides for simply one frame of an ongoing video presentation, one temporal instant of a core data stream (in the case of image (401)) and an interpreted data stream (in the case of image (403)).

In order to provide for the interpretation of the image (401) to image (403) it should be apparent that a number of variables have been utilized by the interpreter (133) in generating the image (403). Specifically, the specifically chosen colors of blobs and the effects chosen may be anything, and therefore the interpreter (133) is provided with a variable as to what color is to be used based on what the interpreter (133) detects in the original image (401). Even the specifics of the interpretation (how big the blobs are or that color blobs as opposed to squares are used) is also based on a variable.

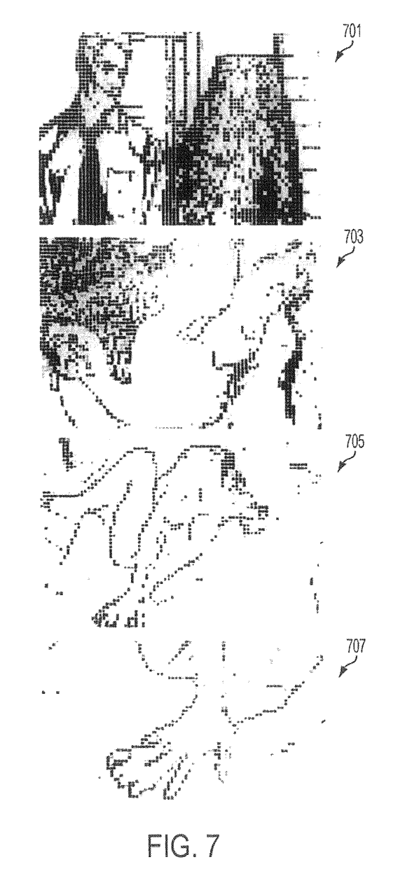

Often, these variables in a simple interpretation are just fixed over time (they are constant), or change based on a predetermined algorithm. For example in FIG. 7, the interpretation involves converting portions of the image of a certain darkness as black pixels, while other areas have been treated as white. As shown from the montage of the four presented images (701), (703), (705) and (707) which represent four temporal spaces frames of a video, the interpretation methodology has not changed over time, with the variables remaining constant. Part of certain darkness are black while others are white. This interpretation provides for a relatively simple interpretation of the images, but provides for the first step of the action of the system (100). The core data stream in this case (an underlying piece of video from which these four images represent, in order, equally separated frames) has been interpreted into an interpreted data stream which is shown by the images (701), (703), (705) and (707), shown relative to the same frames. While it is impossible to fully present a video interpretation in this written document, the montage of sequences should be clear to indicate that the output of the interpreter (133) is a video stream, a constantly refreshing image based on the core stream provided.

As input, color, size, or even appearance of the underlying core data stream may change every instant in time (or every “frame” of video) the resulting image to react in a myriad of different ways even with a relatively fixed interpretation. Therefore the ongoing video presentation (serving as the core signal) will be interpreted to provide a constantly shifting image of the style indicated. Basically an image that need never be the same twice.

To this however, is added the intermixer (137). The intermixer (137) serves to provide to the interpreter (133) a series of variables as a stimulus to alter the manner in which the interpretation occurs over time. So instead of their being a constant interpretation (as shown in FIG. 7) of the frames of input, each frame is actually modified not only by being interpreted, but by being interpreted in a different fashion from the frames around it. Specifically, the variables which influence the interpretation may change at each temporal instant (each “frame” of video).

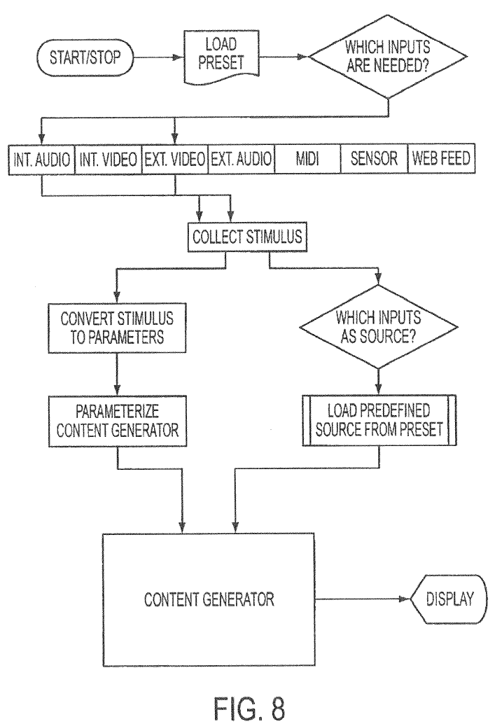

To further understand the operation of the interpreter (133) with the intermixer (137), it makes sense to discuss the operation of signal streams. FIG. 8 provides for a general flowchart indicating the idea of collecting stimuli from a variety of selected sources and then presenting the intermixed and interpreted output on a display. As discussed above a data stream has a temporal component. As such, the specific element of the data stream associated with any instant in time is dependent on the time. Think of it this way. Traditionally video is presented as a series of frames. Each frame is a still image and the images are cycled very quickly so that each is visible for only a certain period of time. It is then hidden and the next image is presented. In this way, the stream of images provides the appearance of movement and presents a moving display. Therefore the specific image of a data stream is determined by the “time” in the stream that is currently being presented.

The core stream will generally be considered the initial building block of the interpreted output stream. In effect, the core stream is modified by other streams. It can be recognized that the core stream could also alter another stream, but simply for ease of understanding, this discussion will treat the core stream as being acted upon. As such, for a visual presentation, the core stream will generally be a stream which can be provided to the display (103) to provide for a visual representation of something on the display (103). This may be a movie or other video form of media. As discussed below, it may also be live generated video images. The stream will comprise temporal data, and as such the video screen will be continuously refreshing the image so as to provide the next frame of data, even if the image appears static.

The core stream will be modified by the interpreter (133) to form an interpreted stream which, while based on the core stream, is a different data stream and therefore provides a different display. In addition to the core stream, there may also be at least one adjusting stream which will serve to provide for an adjustment which will be made to the core stream. The intermixer (137) will provide for the adjusting stream to not affect the core stream globally. Instead, an adjusting stream will also have a temporal component. Thus, for each “frame” of the core stream there will also be a “frame” of the adjusting stream. From the frame of the adjusting stream, the intermixer (137) will select variables which will be used by the interpreter (133) in the interpretation of the core stream to the interpreted stream. Therefore, each frame of the interpreted stream is created from at least two different inputs.

It is generally preferred that the core and adjusting streams each have a designed temporal component. However, the temporal component may be created from otherwise static data. In a simple embodiment, a static piece of digital data may be made temporal by simply reading the data at a predetermined rate to give it a temporal component as discussed. Using this methodology, any type of digital data can be turned into some form of temporal stream and therefore may act as a stimulus for the interpretation.

The adjusting stream will generally serve to adjust at least one variable in the interpretation of the core stream so as to provide for a modification of the core stream wherein each frame of the core stream is modified differently. The modification will relate to temporal component of each media stream at the same instant. To illustrate, for each frame of the video of the core stream, there will be an associated frame of the data of the adjusting stream which occurs at the same time. This frame could be a video frame, an audio “frame” of equivalent time, or simply a piece of data associated with the particular time.

The intermixer (137) will determine from the adjusting stream, the value of a variable (or variables) to be obtained from all the available adjusting streams at that same instant in time (frame). These variables will then be provided to the interpreter (133) as a stimulus and will be used to interpret the core stream frame being acted on (the one associated with the same time period as that from which the variables were selected) to provide for the resulting interpreted stream. Effectively, therefore, each resultant frame of the interpreted stream comprises the core stream being interpreted based on the instantaneously available variables produced from each adjustment stream being fed into the intermixer (137). This is done by extracting information from the adjusting stream at a selected instant. That information then providing variable(s) for the interpreter (133) for that instant, and the interpreter (133) modifies the core stream at the same instant based on the interaction of that variable to the provided interpretation algorithm. The interpreted frame is then presented, and the intermixer (137) and interpreter (133) move to the next frame in the various streams and repeat the process.

In the end, there is provided an interpreted stream whereby the underlying media is not just interpreted in accordance with a fixed variable, or a variable provided by a pre-selected algorithm, but is instead a stream which has meshed multiple media streams by interpreting one stream based on variables provided from another. The result is therefore generally a more organic live generation as it is effectively based on an interaction which may be impossible to recreate.

This combination of data streams is best illustrated by example. Let us assume that the core stream is a video component of a movie. A adjusting stream could then be the combined audio track of the movie. The interpreter (133) may serve, in this example, to alter the video so as to present the image in black and white instead of in color. From the adjustment stream a variable is extracted by the intermixer (137) and provided to the interpreter (133). The adjusting variable can be the current volume of the soundtrack as indicated by total combined sound power. This adjusting variable can then be utilized by the interpreter (133) which will indicate the interaction that each of the adjusting signals is to have on the core signal. In this case let us assume that the controller (101) will cause all white pixels of the core stream to become a darker red as the adjusting signal increases (the higher the total sound power, the more red used) above a predetermined midpoint and become a darker blue (the lower the sound power, the more blue used) the when it decreases below a predetermined midpoint.

From the above, the video signal will shift via a red and blue adjustment as the second signal adjusts, providing that the video looks redder as the sound volume increases, and bluer as the sound volume decreases. This can create either a smoothly shifting pattern of color, or may present wild variations depending on the nature of the sound track. However, the interpreted image will generally be changing in an organic fashion, providing a completely new video image to the user (105) when compared to either of the inputs.

The true power of the interpretation and intermixing comes when more than a single adjusting variable (multiple stimuli) is used from one, or more, adjusting streams. For example, a second adjusting variable could be the current volume being played across a pre-selected radio station which is also received by the controller (101) and will cause the core signal to loosen resolution as the second variable increases, and tighten it as the second variable falls. A still third adjustment variable could cause the core stream to accelerate (fast forward, e.g., providing five frames for every frame of the adjusting streams) if the maximum frequency of sound on the radio increases and decrease in speed (slowing, e.g., to one frame for every five frames of the adjusting streams) if the maximum frequency of sound on the radio decreases.

It should be apparent that as the streams are provided to the controller (101), the visual display will generally be not only in constant motion from the progression of the core stream, but will be constantly color shifting and shifting in and out of focus. Further, the acceleration and deceleration will make the underlying video no longer appear to be a video of known images at all. Still further, the change, now being multi-variable and based oil multiple stimulus which may be semi-random inputs, will allow for the creation of a unique output, which may be unable to be recreated.

It should be apparent that the limitations on how the core stream may be interpreted in conjunction with variable from the adjustment stream(s) are limited solely by the control algorithms available for interpretation, and how many data streams can be used to provide variables. The ability to select the interpretation at any temporal instant provides the first form of interactivity with the user.

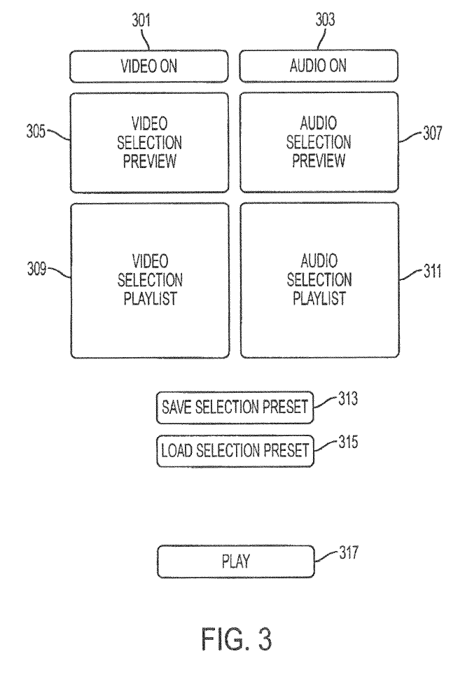

As discussed above, the design of the video output is intended to be interactive and controlled by the user (105) but the above have only contemplated the controller (101) generating the content by the intermixing of the data streams. Interactivity first comes into play by having the user (105) control the controller's (101) “mix” of tracks by allowing the user (105) to select what data streams are to be used at any given time as either a core stream or an adjustment stream. Specifically, the user (105) can utilize the interface (111) to select tracks both at the start the intermixing, and on the fly as the display is generating. This allows the user (105) to generate the resultant video stream in an interactive and generally real-time fashion. As opposed to traditional systems where one would have to enter information and then wait to see the output, system (100), by utilizing the intermixing data streams can provide for instantaneous response. As shown in FIG. 3, the user (105) can select content based on a standard menu. The user (105) may be provided with a menu where they can determine if they want video (301) or audio (303), may get a preview of what section of audio or video is selected (305) or (307), may get a menu of items to select (309) and (311), may save or load presets (313) and (315), and may begin play (interpretation and intermixing) immediately (317). The selection of FIG. 3 is merely one of many possible controls. The user (105) may also select what to do with the tracks such as utilizing the audio track to modify the video track or vice versa. In a still further embodiment, the user can select more than just two streams to utilize.

Further it should be recognized that a user (105) can obtain the streams from either local memory (107) or remote memory (109). Specifically, the user (105) may be performing a live interpretation utilizing two data streams from the local memory, they may then decide that they wish to add a third stream, the soundtrack from a movie which is not on their local machine. They may utilize the connection (153) to go out and seek the desired soundtrack, purchase it or find a public domain copy, and then provide the stream from the remote memory (109) either to the local memory (107) for use, and/or directly to the display (103). The user (105) may also utilize a personal library of media for the inputs, for example a DVD library they own.

It should be further recognized that the process of actually obtaining the new stream can itself present a stream which may be used in the interpretation. The purchase transaction can create a data stream which could be used to transition between the two audio tracks as one is swapped out for the other or the old is supplemented by the new.

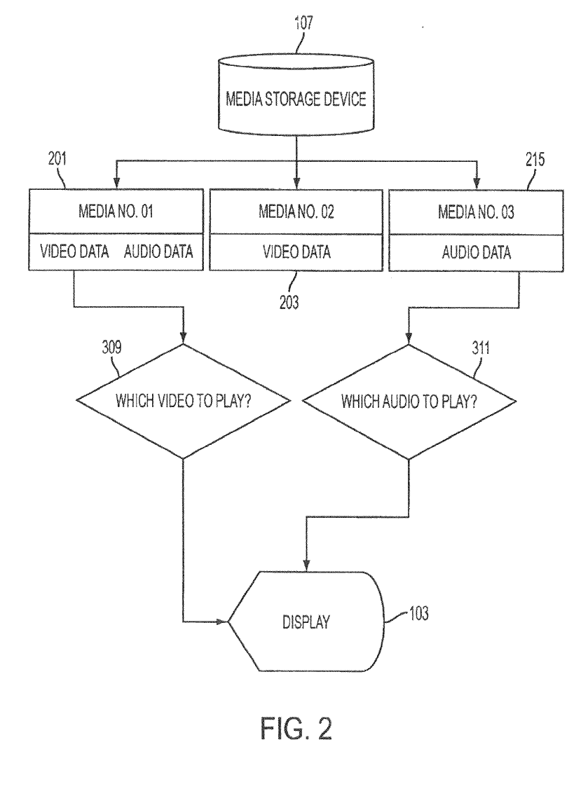

As has been discussed, there is no need to treat preexisting integrated content as a single piece of media (although it may be). In FIG. 1, the functional component of the tuner (135) can serve to separate media which is integrated into separate streams. As illustrated in FIG. 2, in an embodiment the memory, which may be remote memory (109) or local memory (107) or a combination, may include integrated content, such as a recorded movie or a video game screen capture. This content traditionally includes two (or more) streams of information. Specifically, it can include a video track and an audio track. It may even include additional data streams such as other audio tracks (for instance in foreign languages), additional data tracks such as subtitles, or have separate tracks integrated (e.g., dialogue and music). The controller (101), when it loads the data may actually load the data from what is effectively a single input as separate streams of information using the tuner (135). The tuner (135) allows for media data stored together to not be treated as a single media track, as has traditionally been the case, but to allow for the various streams which form a single media track, to be separated and then each used simultaneously. For example, the video and English audio track combined (201), the English audio track alone (205), and the video track alone (203) could be treated as three separate media tracks, elected via a list (309) and (311) as in FIG. 3. One of these tracks may then serve as the core stream, with the remaining track or tracks serving as the adjustment stream or streams to the display (103). In this way, the single “source” has actually served as its own core and adjustment. For example, the audio and visual combined stream may be adjusted by the audio stream as shown in FIG. 3.

In alternative embodiments, similar but different types of effects may be carried out. In one embodiment, the same track may actually serve in multiple different roles. For example, the core stream may comprise the video, while the adjustment stream is formed from the exact same video, delayed by 7 seconds.

It should be recognized from the above that one of the benefits of using the intermixer (137) and interpreter (133) acting on multiple data streams is that the output may be generated in real time. That is, the temporal component of the resultant display may be interconnected with the temporal component of the core stream or any of the adjusting streams. Effectively, the resulting stream is created as the source streams feed through. In this way, the display presents a stream which is flowing as it is created. Because of this it is possible to utilize source streams where the temporal component is expected. In a simple example, an underlying video stream may be played back at normal speed, and interpreted at the same speed and playback. Therefore the user (105) may watch the movie as interpreted without having to wait for interpretation, and may therefore alter the interpretation based on what they see on the screen. There is no delay in their change being entered and immediately resulting in a changed interpretation.

This real-time component provides for a much more interactive experience as the user's (105) indication of a changing stimulus results in an immediate change on the display. This consideration helps to make the response of the display interactive as while the above provides for the creation of digital content live through the live intermixing of existing data streams as stimuli, it is also possible to allow the user (105) to create one or more of the streams instantaneously and act directly as a stimulus or even multiple stimuli.

All the above assume that the media streams used are prerecorded and stored in memory (107) or (109). However, as discussed above anything that can be represented as a temporal data stream may be used as input. Further as discussed above, virtually anything that can be expressed as data readable by the controller can be expressed as a temporal data stream. Therefore, effectively any action of a user can be used to provide for a stimulus allowing the controller (101) to react to virtually any action of the user (105). As shown in FIG. 1, however, there may be included a camera (115), microphone (113), or other multi-variable pickup device which may be capable of converting multi-dimensional input from the user (105) as a live data stream. Using such a system, the user (105) is able not only to mix existing tracks, but to create live tracks through their own actions simultaneously with the mixing and the use of existing tracks. In effect instead of having core or adjusting data stream which are all predefined, any stream may be generated from interaction with the user (105).

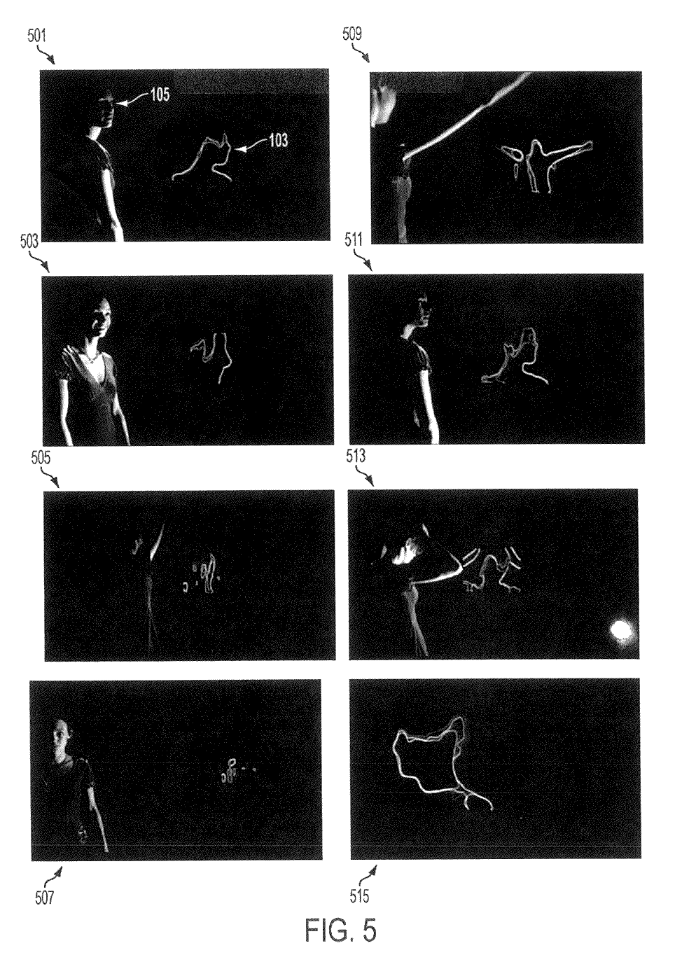

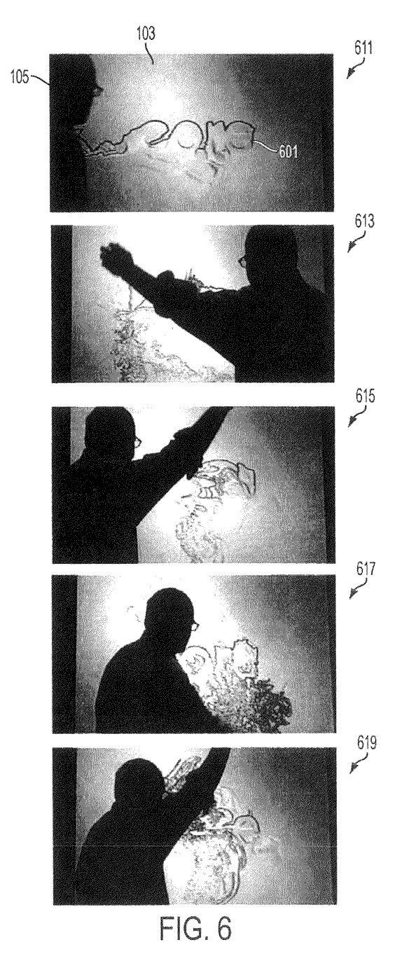

As shown in FIGS. 5 and 6, the user (105) can utilize these recording systems to take in live information from them, such as visual or audio information, which may then be used as core or adjustment streams. Such a system is shown in FIG. 5 whereby the user (105) is acting as a video stream picked up by a camera, which in these embodiments is being interpreted and shown on display (103), but not yet intermixed to show how the live information can be used. As the interpreter (133) is designed to handle temporal information, the actress (105) in this case who is standing in front of the display (103) is being recorded by a camera (115) which is not visible in these images, and the display (103) is showing the immediate action of her after interpretation. The eight images (501), (503), (505), (507), (509), (511), (513) and (515) again provide an image montage for what would be a consecutive video.

In FIG. 5, the controller (101) is performing a form of edge detection and then the interpreter (133) is representing the image it sees as white lines on a blue surface. Further, the controller (101) is also moving the camera's zoom in and out to provide for further interpretation of the image by altering the input stream on its own. The resultant digital source, while it utilizes only a single stream of data, can provide for an image which is quite literally live generated digital art through interpretation.

In FIG. 6 the interpretation is taken one step further. In this depiction, the controller (101) has presented a surface (601) on the display which appears to be liquid. The liquid generation code data therefore comprises the core stream and comprises computer image generation data as opposed to video data as before. As the user (105) moves, the liquid (601) reacts to their movement. In this way, the user's (105) movement is not translated to lines which provide for a depiction of their appearance. Instead, their movement is interpreted to represent something (as detected) moving through the liquid (601) on the display (103). This allows the user (105) to actually interact with the object on the screen (103) more directly instead of being a more basic representation as shown in FIG. 5. In this case, the user (105) is literally interacting with a digital representation of fluid (601) on the screen (103). Once again, the motion is shown as a montage of images (611), (613), (615), (617) and (619) to represent what would be continuous video.

Either of the interpretations of FIGS. 5 and 6 could then be influenced by a further adjustment data stream. To use an example, the movement of the liquid (601) may also be effected by a video stream which is fed into the intermixer (137) and interpreter (133) to result in the liquid (601) having a modification of flow based on the input. For example, the fluid (601) may appear to flow away from movement in a hidden video image.

The user (105) may now interact with the fluid (601) as if they were interacting with a flowing stream or other water source. As the fluid (601) on the display (103) reacts to the underlying video stream, the user (105) can also interact with that flow to try and interfere with it. The resultant appearance on the screen (103) therefore is reacting to both the underlying video and the user (105) actions, as the display (103) presents the joint flow, the user (105) can then react to the joint flow and the interaction between user (105) and display (103) has become recursive, whereby each continues to react to the actions of the other.

Further, it is possible for the user (105) to interact beyond the single input to provide for multiple inputs. Instead of having the alternative flow of the fluid (601) be provided by an underlying video stream acting as the adjustment stream, live generated audio from the user (105), audio may be used as an adjusting stream to move the fluid. In this way, the creation of resulting digital content is more interactive as the user (105) is generating all the adjustment digital streams in use, and simultaneously selecting how they are to be used. Further, the interaction can involve multiple senses. Instead of simply moving and seeing interaction, the user (105) can speak, move, or even have other responses such as blowing air or generating noise by methods other than speech which cause the display (103) to appear to react.

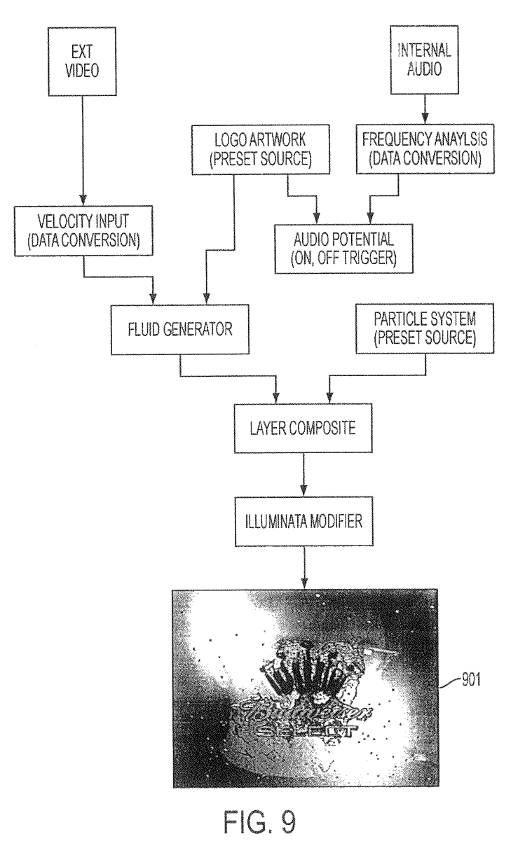

FIG. 9 shows an embodiment of an interactivity diagram showing how a variety of internal interpretations can be combined with a variety of stimulus to produce a resulting image. In the resulting image static information (a product logo) is combined with multiple data streams (a flowing fluid animation, an internal audio track, and a video camera input) in a single display. Further, motion detection on the camera interacts with the fluid generated to provide for interaction of the image. For example, in the image shown at the bottom (901), the user (105) has just moved their head to their left, which has resulted in fluid appearing to move from the static logo in the center of the screen.

In a third embodiment, the user (105) can be effectively taken out of control of the mixing component, and the conscious selection of auxiliary streams to simply become the source of material. In this embodiment, the user (105) provides input, generally in the form of multiple data streams and the controller (101) takes over all the remaining roles with no underlying data stream being selected. The user (105) serves as the core and all adjusting data streams, the interpreter (133) and intermixer (137) serve simply to act on those. Should the user (105) cease interaction, the display (103) goes blank (assuming that nothing else was available to the camera or microphone). In such a system (100), the user (105) is simply doing what they do and the controller (101) is interacting with them, creating images based entirely on what they are doing and how they are interacting. In this way, the user (105) can generate digital artworks or other items whereby they utilize any form of movement or action they desire to be the input, and the controller (101) simply takes that input and based on it, generates an output. This provides for a new way to generate digital content.

One can see that the content can take a variety of forms. In an embodiment, the systems (100) may be designed to provide for interactive advertising where the user (105) is able to interact with a portion of the advertising. For example, the user (105) may be able to make a logo on a billboard move or to otherwise effect the relative positioning of elements of an advertisement. Still further, an interactive billboard could actually react to traffic flow, detecting slower moving traffic not only to trigger but to generate more calming images to help motorists be calmer in a traffic jam and react more positively to the advertising message. Even further, a screen advertisement may react to a user's (105) approach, detecting the user (105) and becoming more animated as they get closer trying to draw them in.

Alternatively, the system (100) may provide for a general entertainment system. At a club or party, the host may activate the system (100) and provide one or more displays (103) which can be observed by guests. The system (100) may be designed to generate content based on the movement of the guests and the speed and volume of sound in the room. In this way, the system (100) may generate content on the display(s) (103) which is indicative of the energy in the room. If the mood is relaxed, such as if houseguests are milling around and socializing as they may at a dinner party, the display(s) (103) may be more subdued providing for a relaxing low-key display which serves to enhance the mood. Alternatively, if the party turned into a powerful music and dance party, the display(s) (103) may become much more active serving to provide for additional excitement and entertainment. Further, regardless of how long the party lasts, or how many times the nature of it changes, the content will generally remain dynamic and ever-changing throughout the entire time without the need for their to be human control of the display(s) (103). Core streams in this case may be stored content associated with the system (100), for instance a program for generating a water flow, or may be content available to the host, for example their DVD or audio library.

Beyond the party, the system (100) may be used more generally as entertainment, allowing individuals to interact with the display (103) in any type of location. Further, the interaction can serve to create a new form of art whereby an artist can utilize their own actions to create art from those actions. This can serve both as a medium, to generate digital art of a more traditional type, as well as a form of performance art itself whereby the user (105) as artist utilizes the system (100) to enhance and create from their own actions providing for a completely unique form of performance whereby the performer is not necessarily the subject of interest. Alternatively, the system (100) could enhance traditional performance art, for example providing a video screen reactive to a rock band and audience during the band's performance.

As has been discussed, while this disclosure focuses on the controller (101) generating a visual display on display (103), that is not required and any other form of temporal output may be created. Therefore in alternative embodiment the resulting interpreted stream may comprise video, audio, or audiovisual data, or could even comprise data of other forms for interaction with different senses. For example, the output could comprises olfactory or even taste sensations which are presented via an appropriate display (103).

While the invention has been disclosed in connection with certain preferred embodiments, this should not be taken as a limitation to all of the provided details. Modifications and variations of the described embodiments may be made without departing from the spirit and scope of the invention, and other embodiments should be understood to be encompassed in the present disclosure as would be understood by those of ordinary skill in the art.

1. A system for generating a visual presentation, the system comprising:
a display, for displaying a visual presentation;
a memory, said memory including at least one piece of media which can be interpreted as a temporal data stream comprising a series of frames, wherein said frames can be presented serially as a visual presentation on said display;
a controller, said controller including
an interpreter, said interpreter being capable of modifying a first temporal data stream associated with a first piece of media so as to utilize a first piece of media to generate a different visual presentation on said display.

2. The system of claim 1, wherein said controller further includes:
An intermixer, said intermixer being capable of utilizing a second temporal data stream associated with a second piece of media to generate a series of variables.

3. The system of claim 2 wherein said series of variables is temporally aligned with said series of frames and said interpreter interprets each of said frames in conjunction with the variables temporally aligned therewith.

4. The system of claim 3 wherein said first piece of media comprises a prerecorded video track.

5. The system of claim 4 wherein said second piece of media comprises a prerecorded audio track.

6. The system of claim 5 wherein said audio track corresponds to said video track as each are from the same integrated content.

7. The system of claim 3 wherein at least one of said first piece of media and said second piece of media is procedurally generated in real-time.

8. The system of claim 7 wherein at least one of said first piece of media and said second piece of media comprises a user generated stimulus.

9. A method of generating output on a display, the method comprising:
providing a controller which includes an intermixer and an interpreter;
providing to said controller at least two data streams;
having said intermixer obtain from at least one of said at least two data streams at least one stimulus, said intermixer providing said stimulus to said interpreter;
having said interpreter utilize said stimulus to modify at least one of said at least two data streams to produce an interpreted data stream;
presenting said interpreted data stream on a display in real-time as it is produced.

10. The method of claim 9 wherein said controller comprises a computer and said intermixer and said interpreter comprise computer software.

11. The method of claim 9 wherein at least one data stream obtained by said intermixer comprises prerecorded video.

12. The method of claim 9 wherein at least one data stream obtained by said intermixer comprises live generated video.

13. The method of claim 9 wherein at least one data stream modified by said interpreter comprises prerecorded video.

14. The method of claim 9 wherein at least one data stream modified by said interpreter comprises live generated video.

15. The method of claim 9 wherein at least one data stream obtained by said intermixer comprises prerecorded audio.

16. The method of claim 9 wherein at least one data stream obtained by said intermixer comprises live generated audio.

17. The method of claim 9 wherein at least one data stream modified by said interpreter comprises prerecorded audio.

18. The method of claim 9 wherein at least one data stream modified by said interpreter comprises live generated audio.

19. A computer readable memory for instructing a computer to generate displayed content, the computer readable memory comprising:
computer readable instructions for obtaining at least one data stream and generating at least one stimulus from said at least one data stream;
computer readable instructions for using said stimulus to modify at least one data stream to produce an interpreted data stream;
computer readable instructions for presenting said interpreted data stream on a display in real-time as it is produced.

20. The computer readable memory of claim 20 wherein only one data stream is used by all of said computer readable instructions.

21. The computer readable memory of claim 20 wherein only at least two different data streams are used by said computer readable instructions.
